(19) United States
(12) Patent Application Publication
(10) Pub. No.: US 2026/0006591 A1
(43) Pub. Date: Jan. 1, 2026

(54) COORDINATION FOR CROSS-LINK INTERFERENCE HANDLING

(71) Applicant: Panasonic Intellectual Property Corporation of America, Torrance, CA (US)

(72) Inventors: Xuan Tuong TRAN, Singapore (SG); Hidetoshi SUZUKI, Kanagawa (JP); Yoshihiko OGAWA, Kanagawa (JP); Quan KUANG, Langen (DE); Hong Cheng Michael SIM, Singapore (SG); Yang KANG, Singapore (SG)

(21) Appl. No.: 19/112,864

(22) PCT Filed: Jul. 26, 2023
(86) PCT No.: PCT/SG2023/050523

§ 371 Date: Mar. 18, 2025

(30) Foreign Application Priority Data
Sep. 30, 2022 (SG) 10202251238X

(51) Int. Cl. H04W 72/0446; H04W 72/27

(52) U.S. Cl. CPC H04W 72/0446; H04W 72/27

(57) ABSTRACT

The present disclosure provides a communication apparatus and a communication method for coordination for cross-link interference handling, the communication apparatus being a base station comprising: circuitry which, in operation, is configured to generate a signal comprising information of a plurality of sets of slot formats for one or more serving cells, wherein each set of slot formats of the plurality of sets of slot formats corresponds to a plurality of frequency segments of each serving cell of the one or more serving cells; and a transmitter which, in operation, transmits the signal to one or more second base stations.

### TECHNICAL FIELD

The following disclosure relates to a communication apparatus and a communication method for coordination with another communication apparatus, and more particularly to inter-gNB (base station) coordination for cross-link interference (CLI) handling.

### BACKGROUND

A new Release 18 study item (SI) named as “study on evolution of near-radio (NR) duplex operation” was approved in RAN #94-e [RP-213591]. One of the main topics is to study how to enable subband non-overlapping full duplex (SBFD) within a legacy Time Division Duplex (TDD) band as it will allow simultaneous existence of downlink (DL) and uplink (UL) within the legacy TDD, where sub-band is used to split transmission directions.

However, when SBFD is deployed, different TDD DL/UL patterns used between neighbouring gNBs (e.g., UL transmission in one gNB and DL reception in another neighbouring gNB) may interfere with each other can result in cross-link interference (CLI). This inter-gNB CLI becomes a critical issue that needs to be handled and there is no solution yet specifying how to realize inter-gNB coordination for inter-gNB CLI handling in SBFD operation.

There is thus a need for a communication apparatus and a communication method for inter-gNB coordination for CLI handling to solve the above-mentioned issues. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for inter-gNB coordination for inter-gNB CLI handling.

In a first aspect, the present disclosure provides a first base station comprising: circuitry which, in operation, is configured to generate a signal comprising information of a plurality of sets of slot formats for one or more serving cells, wherein each set of slot formats of the plurality of sets of slot formats corresponds to a plurality of frequency segments of each serving cell of the one or more serving cells; and a transmitter which, in operation, transmits the signal to one or more second base stations.

In a second aspect, the present disclosure provides a second base station comprising: a receiver which, in operation, a signal from a first base station, the signal comprising information of a plurality of sets of slot formats, wherein each set of slot formats of the plurality of sets of slot formats corresponds to a plurality of frequency segments of each serving cell of the one or more serving cells, wherein the each serving cell of the one or more serving cells is affiliated with the first base station; and circuitry which, in operation, is configured to perform a scheduling procedure based on the information.

In a third aspect, the present disclosure provides a third base station, wherein a first serving cell and one or more second serving cells are affiliated with the third base station, comprising: circuitry which, in operation, is configured to generate a signal comprising information of a set of slot formats for the first serving cell, wherein the set of slot formats corresponds to a plurality of frequency segments of the first serving cell; and a transmitter which, in operation, transmits the signal to the one or more second serving cells.

In a fourth aspect, the present disclosure provides a communication method comprising: generating a signal comprising information of a plurality of sets of slot formats for one or more serving cells, wherein each set of slot format of the plurality of sets of slot formats corresponds to one of a plurality of frequency bands of each serving cell of the one or more serving cells; and transmitting the signal to one or more second base stations.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 shows an exemplary 3GPP next generation radio access network (NG-RAN) architecture to which exemplary embodiments of the present disclosure may be applied.

FIG. 2 depicts a schematic drawing which shows functional split between NG-RAN and 5GC to which exemplary embodiments of the present disclosure may be applied.

FIG. 3 depicts a sequence diagram for radio resource control (RRC) connection setup/reconfiguration procedures to which exemplary embodiments of the present disclosure may be applied.

FIG. 4 depicts a schematic drawing showing usage scenarios of Enhanced mobile broadband (eMBB), Massive Machine Type Communications (mMTC) and Ultra Reliable and Low Latency Communications (URLLC) to which exemplary embodiments of the present disclosure may be applied.

FIG. 5 shows a block diagram showing an exemplary 5G system architecture for Vehicle-to-everything (V2X) communication in a non-roaming scenario.

FIG. 6 shows a diagram illustrating a configuration update procedure between two gNBs.

FIG. 7 shows a schematic diagram illustrating an overall architecture of NG-RAN and 5GC, where a gNB is shown in a split gNB scenario which includes a gNB central unit (gNB-CU) and multiple gNB distributed units (gNB-DUs).

FIG. 8 shows a diagram illustrating a configuration update procedure between a gNB distributed unit (gNB-DU) and a gNB central unit (gNB-CU) in a split gNB scenario.

FIG. 9 depicts two block diagrams illustrating a legacy (Release 15/16/17) time division duplex (TDD) and a Release 18 sub-ban non-overlapping full duplex (SBFD), respectively.

FIG. 10 depicts an example of a conventional inter-gNB coordination with cross-link interference (CLI).

FIG. 11A shows a legacy TDD format used in Release 16 inter-gNB coordination for inter-gNB CLI handling.

FIG. 11B shows an exemplary TDD format used in inter-gNB coordination according to various embodiments of the present disclosure for inter-gNB CLI handling.

FIG. 12 shows a schematic example of communication apparatus in accordance with various embodiments.

FIG. 13 shows a flowchart illustrating a communication method implemented by a first communication apparatus according to various embodiments of the present disclosure.

FIG. 14A shows a block diagram illustrating an exemplary TDD band with fully overlapped/shared sub-band allocations for inter-gNB coordination for inter-gNB CLI handling according to the first embodiment of the present disclosure.

FIG. 14B shows a block diagram illustrating an exemplary TDD band with partial overlapped/shared sub-band allocations for inter-gNB coordination for inter-gNB CLI handling according to the second embodiment of the present disclosure.

FIG. 15 shows a flowchart illustrating a first exemplary inter-gNB coordination process for gNB CLI handling according to the first embodiment of the present disclosure.

FIG. 16 shows a flowchart illustrating a second exemplary inter-gNB coordination process for gNB CLI handling according to the first embodiment of the present disclosure.

FIG. 17 shows a flowchart illustrating a third exemplary inter-gNB coordination process for gNB CLI handling according to the first embodiment of the present disclosure.

FIG. 18 shows a block diagram illustrating an exemplary TDD band with new semi-static slot format for inter-gNB coordination for inter-gNB CLU handling according to an embodiment of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

The second version of the 5G standard was completed in June 2020, which further expand the reach of 5G to new services, spectrum and deployment such as unlicensed spectrum (NR-U), non-public network (NPN), time sensitive networking (TSN) and cellular-V2X.

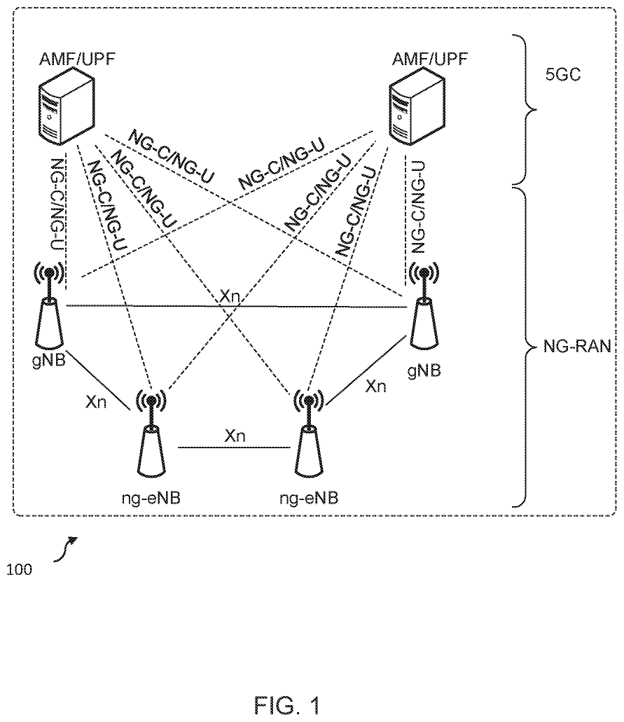

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 1 (see e.g., 3GPP TS 38.300 v16.3.0).

The user plane protocol stack for NR (see e.g., 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g., sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY hybrid automatic repeat request (HARQ) processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink, PDSCH (Physical Downlink Shared Channel), PDCCH (Physical Downlink Control Channel) and PBCH (Physical Broadcast Channel) for downlink, and PSSCH (Physical Sidelink Shared Channel), PSCCH (Physical Sidelink Control Channel) and Physical Sidelink Feedback Channel (PSFCH) for sidelink (SL).

SL supports UE-to-UE direct communication using the SL resource allocation modes, physical layer signals/channels, and physical layer procedures. Two new radio (NR) SL resource allocation modes are supported: (a) mode 1, where the NR SL resource allocation is provided by the network; and (b) mode 2, where UE decides NR SL transmission resource in the resource pool(s). Two SL resource allocations modes are applicable to LTE V2X: (a) mode 3, where the LTE SL resource allocation is scheduled by eNB primarily for transmission of periodically-occurring messages; and (b) mode 4, where the UE decides autonomously the LTE SL transmission resource in the resource pool(s).

PSCCH indicates resource and other transmission parameters used by a UE for PSSCH. PSCCH transmission is associated with a demodulation reference signal (DM-RS). PSSCH transmits the transport blocks (TBs) of data themselves, and control information for HARQ procedure and channel state information (CSI) feedback triggers, etc. At least 6 Orthogonal Frequency Division Multiplex (OFDM) symbols within a slot are used for PSSCH transmission. PSSCH transmission is associated with a DM-RS and may be associated with a phase-tracking reference signal (PT-RS).

PSPCH carries HARQ feedback over the SL from a UE which is an intended recipient of a PSSCH transmission to the UE which performed the transmission. PSFCH sequence is transmitted in one PRB repeated over two OFDM symbols near the end of the SL resource in a slot.

The SL synchronization signal consists of SL primary and SL secondary synchronization signals (S-PSS, S-SSS), each occupying 2 symbols and 127 subcarriers. Physical Sidelink Broadcast Channel (PSBCH) occupies 9 and 5 symbols for normal and extended cyclic prefix cases respectively, including the associated demodulation reference signal (DM-RS).

Regarding physical layer procedure for HARQ feedback for sidelink, SL HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In SL resource allocation mode 1, a UE which received PSFCH can report SL HARQ feedback to gNB via PUCCH or PUSCH.

Regarding physical layer procedure for power control for sidelink, for in-coverage operation, the power spectral density of the SL transmissions can be adjusted based on the pathloss from the gNB, whereas for unicast, the power spectral density of some SL transmissions can be adjusted based on the pathloss between the two communicating UEs.

Regarding physical layer procedure for CSI report, for unicast, channel state information reference signal (CSI-RS) is supported for CSI measurement and reporting in sidelink. A CSI report is carried in a SL MAC CE.

For measurement on the sidelink, the following UE measurement quantities are supported:
PSBCH reference signal received power (PSBCH RSRP);
PSSCH reference signal received power (PSSCH-RSRP);
PSCCH reference signal received power (PSCCH-RSRP);
Sidelink received signal strength indicator (SL RSSI);
Sidelink channel occupancy ratio (SL CR);
Sidelink channel busy ratio (SL CBR).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km2 in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (also known as transmission time interval (TTI)) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

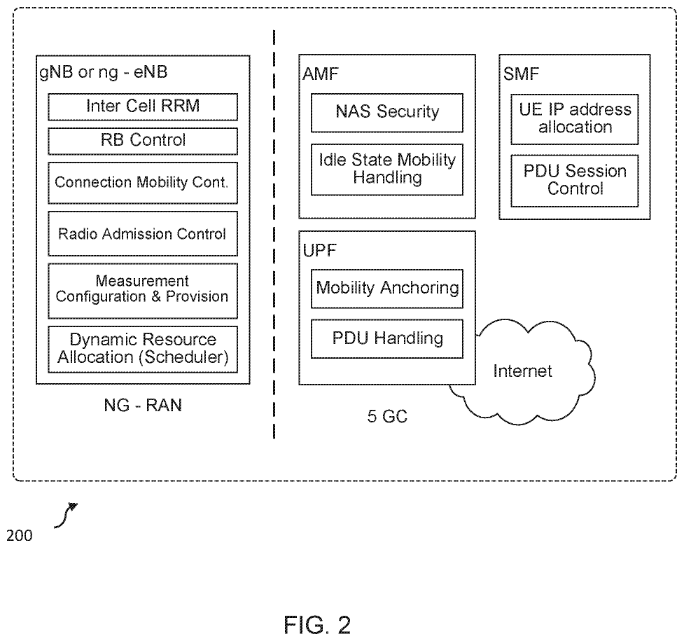

FIG. 2 illustrates functional split between NG-RAN and 5GC to which exemplary embodiments of the present disclosure may be applied. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g., packet filtering, gating, UL/DL rate enforcement;
Uplink Traffic verification (SDF to QoS flow mapping);
Downlink packet buffering and downlink data notification triggering.

Finally, the Session Management function, SMP, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

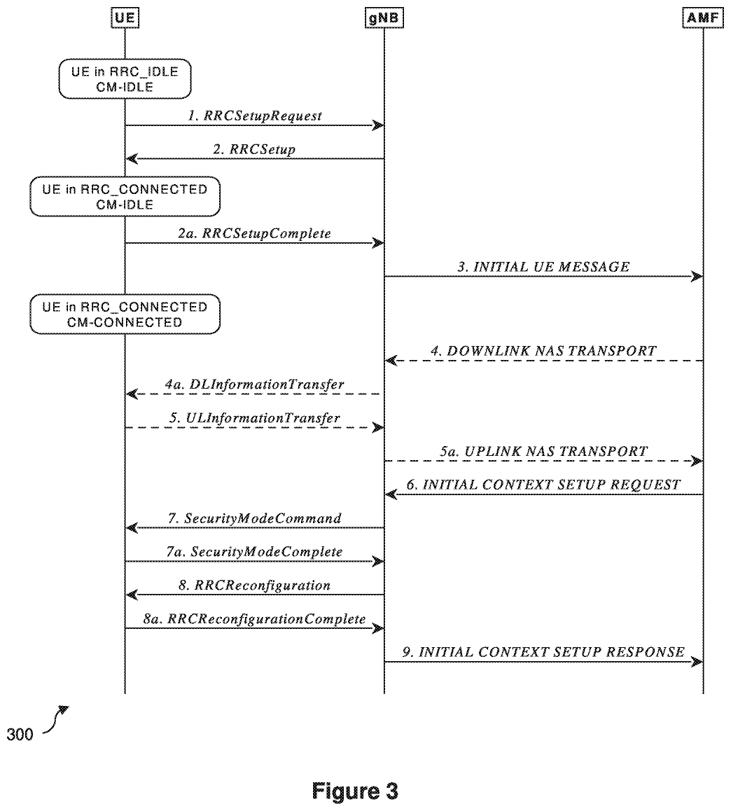

FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502.
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AMF prepares the UE context data (including e.g., PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UB a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

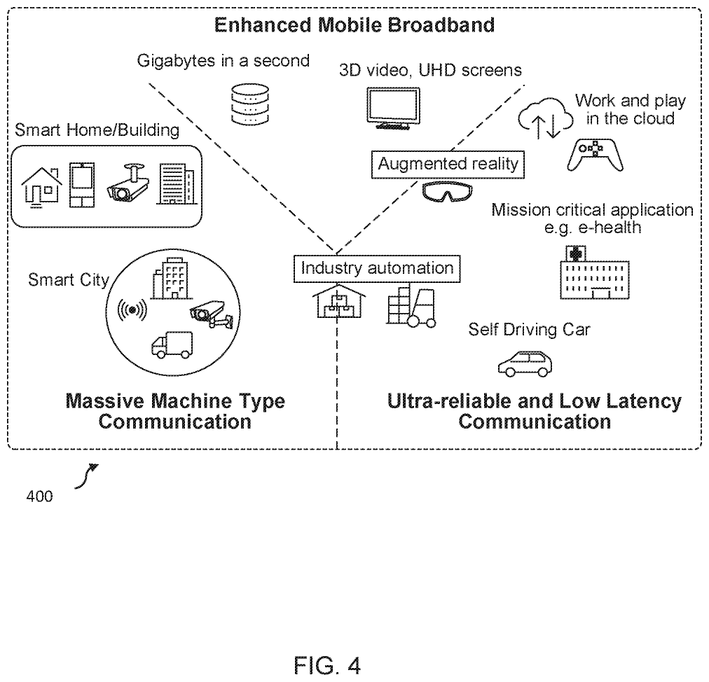

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g., ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of Ims.

From the physical layer perspective, reliability can be improved in a number of possible ways. The current scope for improving the reliability involves defining separate CQI tables for URLLC, more compact Downlink Control Information (DCI) formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10-6 level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both Qos flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g., as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

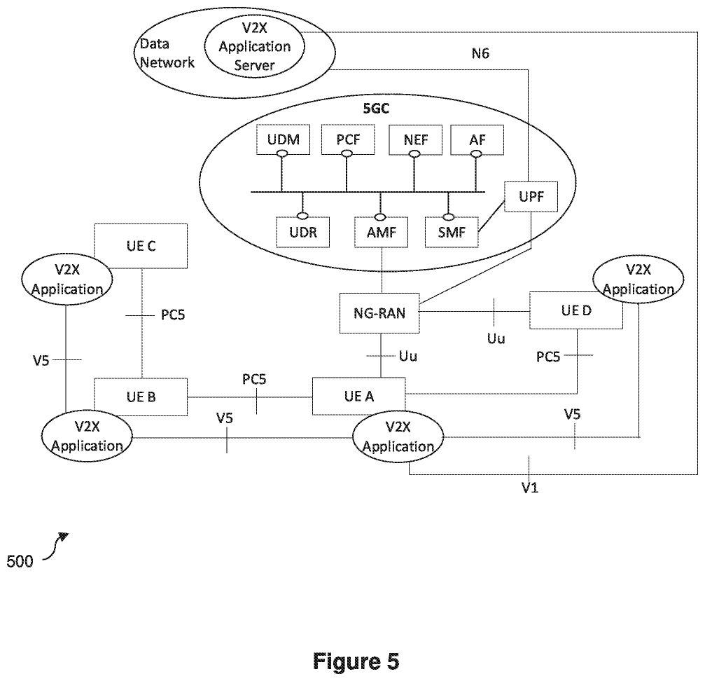

FIG. 5 illustrates a 5G NR non-roaming reference architecture (see TS 23.287 v16.4.0, section 4.2.1.1). An Application Function (AF), e.g., an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g., operator services, Internet access or 3rd party services. All or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMBB and mMTC services to at least one of functions (for example NEF, AMF, SMF, PCF, UPF, etc) of the 5GC to establish a PDU session including a radio bearer between a gNodeB and a UE in accordance with the Qos requirement and control circuitry, which, in operation, performs the services using the established PDU session.

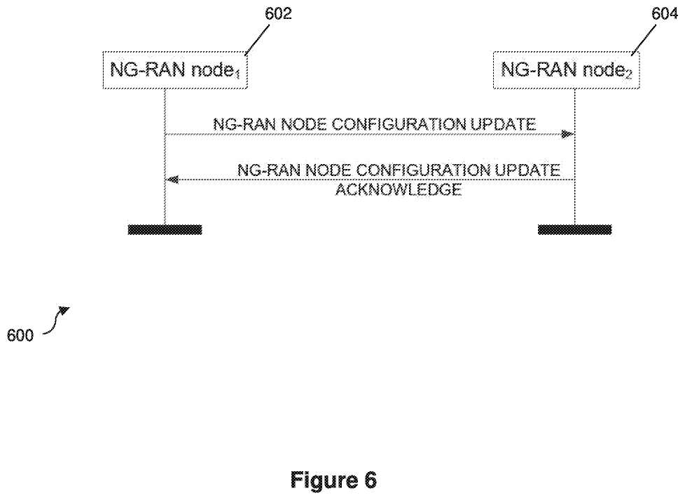

FIG. 6 shows a diagram illustrating a configuration update procedure between two next generation radio access network (NG-RAN) nodes 602, 604. A configuration update procedure is to update configuration message needed for two NG-RAN nodes to interoperate correctly over the Xn-C interface. A NG-RAN logical node 1 (also known as gNB or ng-eNB) first initiates a configuration update procedure by sending a NG-RAN configuration update message to a peer NG-RAN node 2. The NG-RAN node 2 responds with gNB-DU configuration update acknowledge message to acknowledge that it successfully updated the configuration data. If the NF-RAN node 2 cannot accept the update, it shall respond with a NG-RAN node configuration update failure message and appropriate cause value.

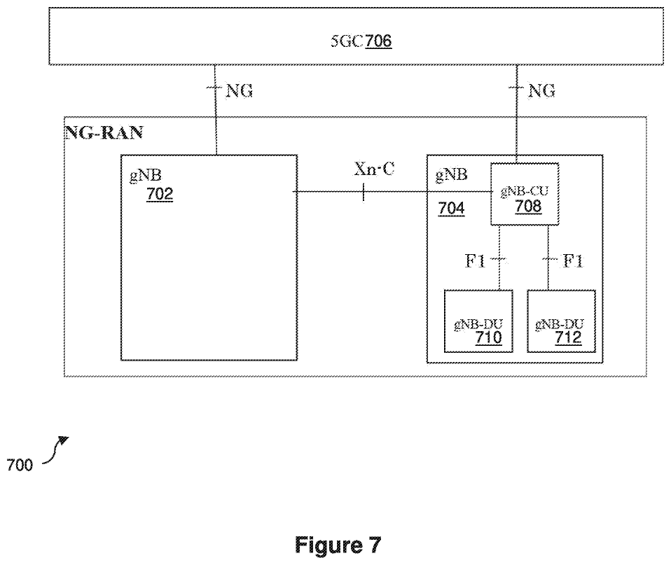

FIG. 7 shows a schematic diagram 700 illustrating an overall architecture of NG-RAN and 5GC, where a gNB is shown in a split gNB scenario which includes a gNB central unit (gNB-CU) and multiple gNB distributed units (gNB-DUs). The NG-RAN 700 comprises a set of gNB (e.g., gNBs 702, 704 connected to a 5GC 706 through a NG interface. The set of gNBs 702, 704 are interconnected through a Xn interface. A gNB (e.g., gNB 704) may consist of a gNB-CU 708 and one or more gNB-DUs 710, 712. A gNB-CU 708 and a gNB-DU 710, 712 is connected via F1 interface. One gNB-DU 710, 712 is connected to only one gNB-CU 708. NG, Xn and F1 are logical interfaces.

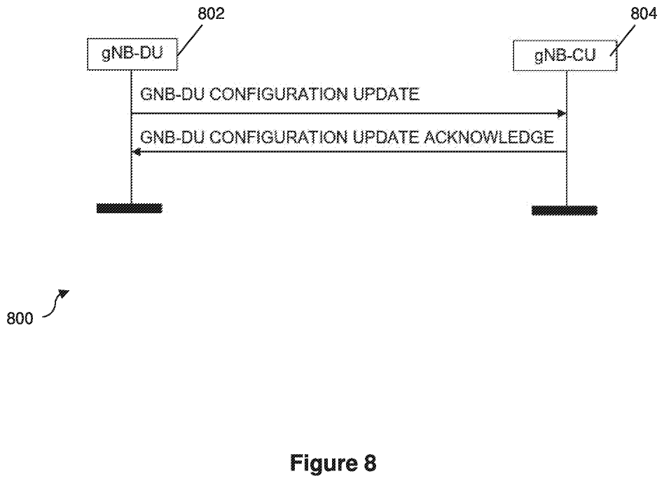

FIG. 8 shows a diagram 800 illustrating a configuration update procedure between a gNB distributed unit (DU) 802 and a gNB central nit (CU) 804. The gNB-DU 802 first initiates a configuration update procedure by sending a gNB-DU configuration update message to the gNB-CU including an appropriate set of updated configuration data that it has just taken into operation use. The gNB-CU 804 responds with gNB-DU configuration update acknowledge message to acknowledge that it successfully updated the configuration data. The updated configuration data shall be stored in both nodes 802, 804 and used as long as there is an operational transport network layer (TNL) association or until any further update is performed. If the gNB-CU 804 cannot accept the update, it shall respond with a gNB-DU configuration update failure (not shown) message instead and appropriate cause value.

As mentioned above, a new Release 18 study item named as “study on evolution of NR duplex operation” was approved in RAN #94-e [RP-213591], and one of the main topics is to study how to enable sub-band non-overlapping full duplex (SBFD) within a legacy TDD band. For gNB side, (quasi) full duplex is done, while for UE side, half-duplex can be used.

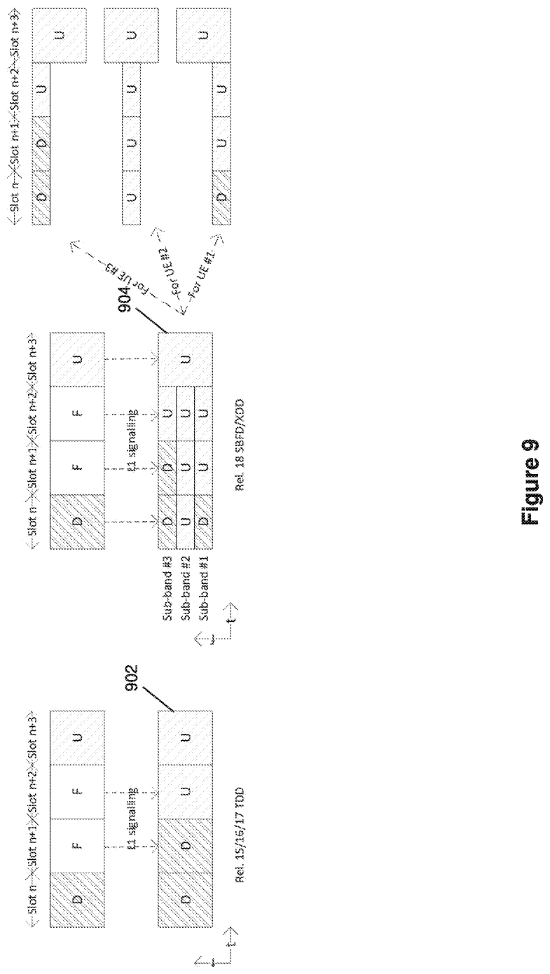

FIG. 9 depicts an example legacy TDD slot format 902 according to Release 15/16/17 and an example SBFD or cross-division duplex (XDD) slot format 904 for inter-gNB coordination. In this example, the legacy TDD band and the SBFD/XDD are changed from an initial TDD band of four slots (four different time resource allocations) with slot formats “DFFU” upon L1 signalling, where slot formats “D”, “U” and “F” correspond to downlink communication, uplink communication and semi-static flexible (uplink and/or downlink) communication, respectively. Up on reception of L1 signalling, the second and third slot formats of the legacy TDD band are changed from “F” to “D” and “U”, respectively. For SBFD/XDD, the first three slots (slots n, n+1 and n+2) of the TDD band are split into three different sub-bands (three different frequency resource allocation), each having its own slot formats upon L1 signalling. As such, it allows simultaneous existence of DL and UL within the legacy TDD band, for example, the first slot formats in the first, second and third sub-bands are “D”, “U” and “D”, respectively. The sub-bands are then used to split transmission directions, for example to three different UEs. For slot that is not split, e.g., slot n+3, the slot format across the frequency domains will be transmitted to uplink transmission directions. Herein, for an example, the slot formats “DDUU” in the first sub-band #1 are sent to UE #1, the slot formats “UUUU” second sub-band #2 are sent to UE #2 and the slot formats “DUUU” in the third sub-band #3 are sent to UE #3. With this operation, it is motivated to provide more UL time duration to enhance UL coverage, reduce latency and increase UL capacity.

In TDD, when different TDD DL/UL patterns (slot formats) are used between neighbouring cells/gNBs, UL transmission in one cell/gNB may interfere with DL reception in another cell/gNB, and this is called cross-link interference (CLI). It has been observed that the UL performance of small cells with dynamic TDD DL/UL pattern (or dynamic slot format) is significantly impacted by strong gNB-gNB CLI from macro cell with DL-heavy TDD configuration, according to R1-2204432. In other words, the victim gNB is significantly impacted by the strongest CLI aggressor cell (e.g., the closest macro-gNB). When SBFD operation is deployed, the same observations still hold true, and inter-gNB CLI becomes a critical issue that needs to be handled. Hence, it is stated in RP-213591 as one of the main topics to study inter-gNB and inter-UE CLI handling and identify solutions to manage them.

In RAN #1109e, some candidate schemes for inter-gNB CLI handling in SBFD operation have been proposed for further study in the following, where the coordinated scheduling scheme is the main focus, and inter-gNB CLI may be either adjacent-channel CLI or co-channel-CLI, or both, depending on the deployment scenario.

According to the RANI #109e agreement, for study of potential enhancement to dynamic/flexible TDD and/or SBFD, followings are considered as candidates of potential enhancement method of gNB-to-gNB CLI handling, where further prioritization/down-scoping of candidate schemes for study can be done in the future meetings:
gNB-to-gNB CLI measurement and reporting
Coordinated scheduling
Spatial domain enhancements
Advanced receiver
UE and gNB transmission and reception timing
Power control-based solution
Potential enhancements to Rel-16 RIM
Sensing based mechanism
Note: Whether or not a particular scheme requires OTA or backhaul information exchange should be identified
Note: Any other scheme(s) for inter-gNB CLI handling is/are not precluded.
Note: For potential enhancements to dynamic/flexible TDD and/or SBFD, utilize the outcome of discussion in Rel-15 and Rel-16 while avoiding the repetition of the same discussion.
Note: Potential enhancements specific for SBFD will be discussed in 9.3.2

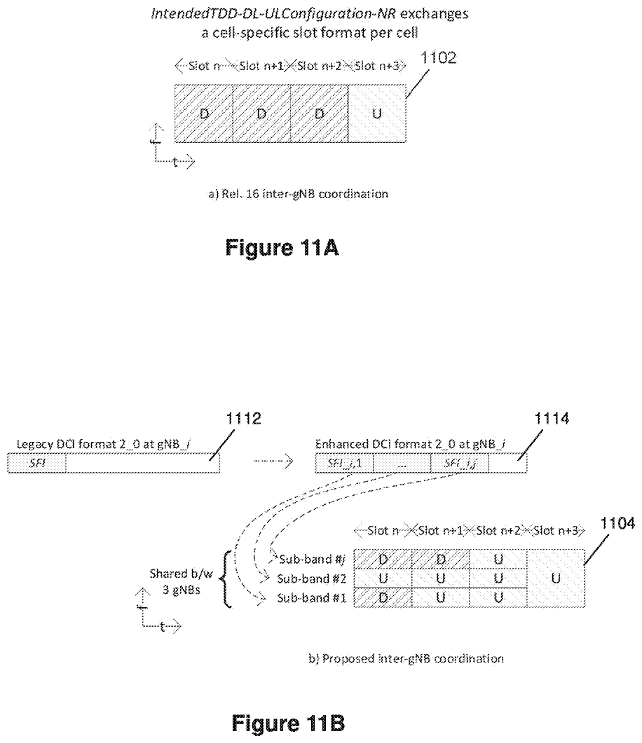

For inter-gNB CLI handling in TDD, Release 16 inter-gNB coordination (e.g. TS38.423 v16.10.0) supports to exchange the intended TDD DL-UL configuration over Xn/F1 interfaces in a semi-static manner (i.e., a semi-static slot format and a cell-specific slot format configuration exchanged between gNBs by a higher-layer parameter IntendedTDD-DL-ULConfiguration-NR, see FIG. 11A). The gNB(s) needs to consider this information exchange when doing their own scheduling for inter-gNB CLI handling.

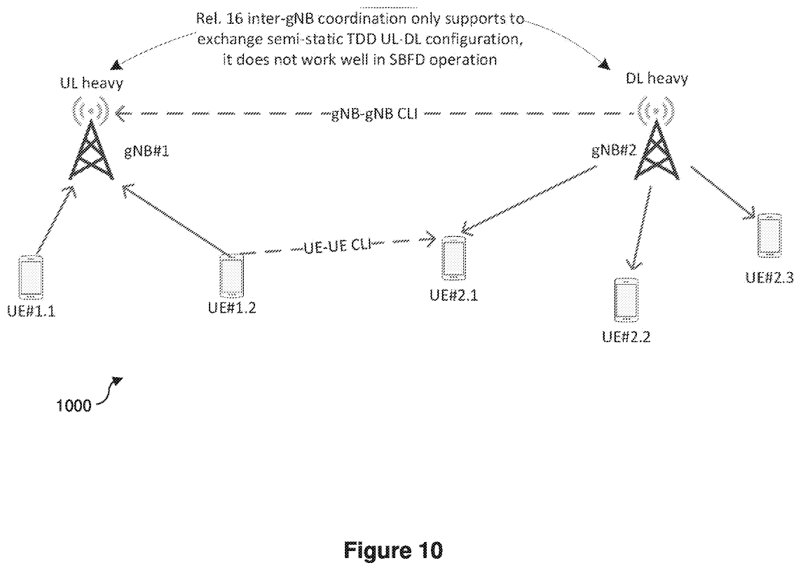

While inter-gNB CLI handling in TDD has been discussed, it is not specified on how to realize inter-gNB coordination for inter-gNB CLI handling in SBFD operation. FIG. 10 depicts a schematic diagram illustrating a conventional Release 16 inter-gNB coordination through TDD operation. If a UE with SBFD capability tries to use Release 16 inter-gNB coordination, the performance of CLI handling may be not desirable because the Release 16 inter-gNB coordination only supports to exchange a semi-static and a cell-specific TDD UL-DL configuration, and it does not support to exchange dynamic slot format or a sub-band-based configuration between gNB, hence it does not work well in SBFD operation.

On the other hand, SBFD operation might support the slot formats that are dynamically indicated by slot format indicator (SFI) in Downlink Control Information (DCI) format 2_0) (e.g., slot formats #46-55 as defined in the section 11.1.1 of TS38.213) or new slot formats. The frequency-domain resource allocation (i.e., sub-band allocations) for DL-UL slot/symbol in SBFD operation might be different from that of the TDD operation shown in FIG. 10 such that it creates different total amount of CLI measured by neighbouring gNB(s). Hence, the neighbouring gNBs do not have sufficient information to adjust their own scheduling for inter-gNB CLI handling.

For inter-gNB coordination for CLI handling according to the present disclosure, the multiple slot formats per cell are exchanged between gNBs, each of the multiple slot formats corresponding to each sub-band in a cell. The sub-bands include frequency-domain resource allocation (e.g., resource blocks (RBs)/physical RBs (PRBs), into which a band of the cell is divided. The sub-bands do not overlap each other, and they are used to split transmission directions.

FIG. 11A shows a legacy TDD format 1102 used in Release 16 inter-gNB coordination for inter-gNB CLI handling. In Release 16 inter-gNB coordination, only a cell-specific format slot per cell for a legacy TDD band is exchanged over Xn/F1 interfaces in a semi-static manner between gNBs by current higher-layer parameter IntendedTDD-DL-ULConfiguration-NR.

FIG. 11B shows an exemplary TDD format 1104 used in inter-gNB coordination according to various embodiments of the present disclosure for inter-gNB CLI handling. In the inter-gNB coordination of the present disclosure, multiple slot formats per cell per gNB (e.g., UE-specific slot formats) based on the set of sub-bands (e.g., sub-band #1, sub-band #2, . . . , sub-band #j) within a serving cell (or the legacy TDD band) can be exchanged over Xn/F1 interfaces in a semi-static manner between gNBs. This may be exchanged by current higher-layer parameter IntendedTDD-DL-ULConfiguration-NR or a new higher-layer parameter to support inter-gNB CLI handling in SBPD operation.

Table 1 shows an example slot format indicator information, i.e., multiple slot formats per cell per gNB (e.g., gNB₁, gNB₂, gNB₃; or gNB under the index number 1, 2, 3) exchanged between gNBs for inter-gNB coordination for inter-gNB CLI handling according to various embodiments of the present disclosure. In this example, assuming a gNB serves a cell, SFI_{i,j} indicates the slot format for gNB index i and sub-band index j, e.g., in Table 1, the first column shown gNB index i=1, . . . , 3, the second column shows multiple slot formats for sub-band indices from 1 to j such that SFI_{i,j} is the slot format used for sub-band #j of gNBᵢ.

TABLE 1
Example of exchanging multiple slot formats per
cell per gNB, wherein each gNB serves a cell.

| | | Validity period |
|---|---|---|
| gNB index gNBᵢ | Multiple slot format SFI_{i, j} | (Optional) |
| 1 | SFI_{1, j}, . . . , SFI_{1, j} | a (ms or slots) |
| 2 | SFI_{2, j}, . . . , SFI_{2, j} | b (ms or slots) |
| 3 | SFI_{3, j}, . . . , SFI_{3, j} | c (ms or slots) |

For the case when a gNB serves multiple cells, the slot format for each cell from multiple cells of the gNB can be expressed as SFI_{i,j,k}, where i denotes gNB index. j denotes cell index, and k denotes sub-band index, as shown in Table 2.

TABLE 2
Example of exchanging multiple slot formats per cell per
gNB, wherein each gNB serves multiple cells period

| gNB index | Cell | | Validity period |
|---|---|---|---|
| gNBᵢ | index j | Multiple slot format SFI_{i, j, k} | (Optional) |
| 1 | 1 | SFI_{1, 1, k}, . . . , SFI_{1, 1, k} | a1 (ms or slots) |
| | 2 | SFI_{1, 2, k}, . . . , SFI_{1, 2, k} | a2 (ms or slots) |
| | 3 | SFI_{1, 3, k}, . . . , SFI_{1, 3, k} | a3 (ms or slots) |
| 2 | 1 | SFI_{2, 1, k}, . . . , SFI_{2, 1, k} | b1 (ms or slots) |
| | 2 | SFI_{2, 2, k}, . . . , SFI_{2, 2, k} | b2 (ms or slots) |
| | 3 | SFI_{2, 3, k}, . . . , SFI_{2, 3, k} | b3 (ms or slots) |
| 3 | 1 | SFI_{3, 1, k}, . . . , SFI_{3, 1, k} | c1 (ms or slots) |
| | 2 | SFI_{3, 2, k}, . . . , SFI_{3, 2, k} | c2 (ms or slots) |
| | 3 | SFI_{3, 3, k}, . . . , SPI_{3, 3, k} | c3 (ms or slots) |

Optionally, the validity period of the multiple slot formats for each gNB (e.g., gNB₁, gNB₂, gNB₃) in terms of millisecond (ms) or number of slots is also exchanged. In addition, the validity period can be defined by a high-layer parameter, such as the high-layer parameter NRDL-ULTransmissionPeriodicity in specifications.

According to the present disclosure, after the multiple slot formats per cell are exchanged between gNBs, an enhanced DCI format 2_0 1114, enhanced from the legacy DCI format 2_0 1112, is used to support the function to indicate the multiple slot formats (SFI) per cell for each gNB. The enhanced DCI format 2_0 includes all or a part of the SFIs at different rows and columns (frequency and time resource allocations), and such DCI can be used by a gNB (in this case gNB_i). It may split the TDD band 1104 into the corresponding number of sub-bands at different time domains. In this example, the TDD band is split into three sub-bands corresponding to three gNB indices (number of rows) and the sub-bands are then used to split transmission directions, for example to gNB₁, gNB₂, gNB₃, respectively. Note that instead of enhancing DCI format 2_0, other DCI formats can be enhanced to indicate the multiple slot formats as well, e.g., DCI format is dedicatedly configured to the UE.

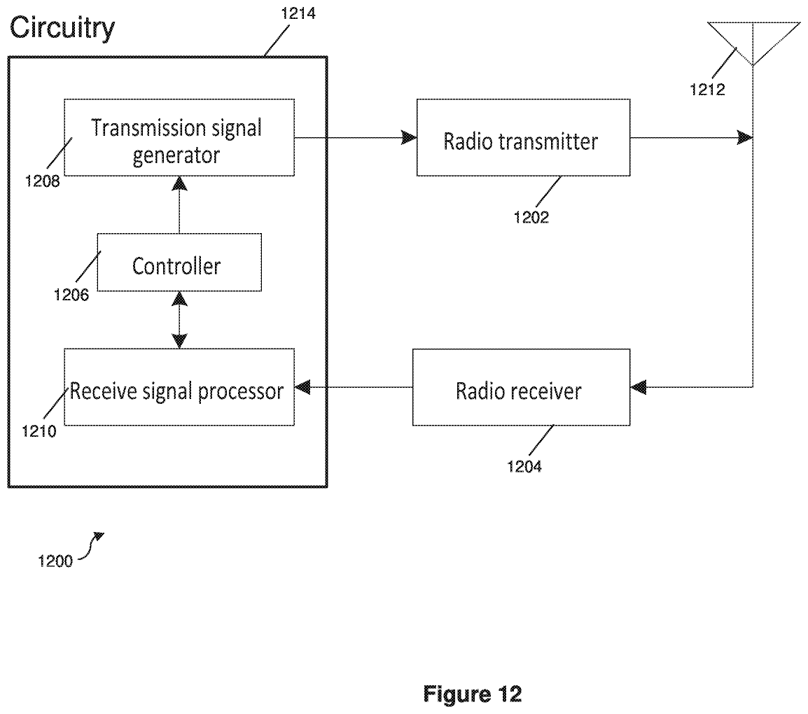

FIG. 12 shows a schematic diagram illustrating an example configuration of a communication apparatus 1200 for inter-gNB coordination for inter-gNB CLI handling in accordance with various embodiments of the present disclosure. The communication apparatus 1200 may be implemented a base station configured for a signal transmission or reception in accordance with the present disclosure. As shown in FIG. 12, the communication apparatus 1200 may include circuitry 1214, at least one radio transmitter 1202, at least one radio receiver 1204, and at least one antenna 1212 (for the sake of simplicity, only one antenna is depicted in FIG. 12 for illustration purposes). The circuitry 1214 may include at least one controller 1206 for use in software and hardware aided execution of tasks that the at least one controller 1206 is designed to perform, including control of communications with one or more other communication apparatuses in a multiple input and multiple output (MIMO) wireless network. The circuitry 1214 may furthermore include at least one transmission signal generator 111208 and at least one receive signal processor 1210. The at least one controller 1206 may control the at least one transmission signal generator 1208 for generating a downlink signal or a sidelink signal to be sent through the at least one radio transmitter 1202 and the at least one receive signal processors 1210 for processing an uplink signal, a downlink signal or a sidelink signal received through the at least one radio receiver 1204 from the one or more other communication apparatuses. The at least one transmission signal generator 1208 and the at least one receive signal processor 1210 may be stand-alone modules of the communication apparatus 1200 that communicate with the at least one controller 1206 for the above-mentioned functions, as shown in FIG. 12. Alternatively, the at least one transmission signal generator 1208 and the at least one receive signal processor 1210 may be included in the at least one controller 1206. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1202, at least one radio receiver 1104, and at least one antenna 1212 may be controlled by the at least one controller 1206.

The communication apparatus 1200, when in operation, provides functions required for inter-gNB coordination for inter-gNB CLI handling. For example, the communication apparatus 1200 may be a first base station and the circuitry 1214 (or the at least one transmission signal generator 1208 of the circuitry 1214) may be configured to generate a signal comprising information of a plurality of sets of slot formats for one or more serving cells, wherein each set of slot formats of the plurality of sets of slot formats corresponds to a plurality of frequency segments of each serving cell of the one or more serving cells, and the at least one radio transmitter 1202 may transmit the signal to one or more other communication apparatuses.

In an embodiment, the plurality of frequency segments of the each serving cell of the one or more serving cells is formulated by dividing frequency band of the each serving cell of the one or more serving cells.

In one embodiment, the circuitry 1214 (or the at least one transmission signal generator 1208 of the circuitry 1214) may be configured to generate the signal in response to an expiration of a validity period.

In another embodiment, the at least one radio transmitter 1202 may further transmit second information based on the information of the plurality of sets of slot formats to at least one of a plurality of user equipment using one or a combination of a higher layer parameter or a downlink control information.

Yet in another embodiment, the at least one radio receiver 1204 may receive a request from one of the one or more second base stations, and the circuitry 1214 (or the at least one transmission signal generator 1208 of the circuitry 1214) may be configured to generate a plurality of new sets of slot formats corresponding to the plurality of frequency segments for the one or more serving cells and the signal comprising the information of the plurality of new sets of slot formats in response to receiving the request.

In one embodiment, the circuitry 1214 (or the at least one transmission signal generator 1208 of the circuitry 1214) may be configured to generate a second signal comprising information of a plurality of updated frequency segments, wherein the each set of slot formats of the plurality of sets of slot formats corresponds to the plurality of updated frequency segments of the ach serving cell of the one or more serving cells.

For example, the communication apparatus 1200 may be a second base station and the at least one radio receiver 1204 may receive a signal from another communication apparatus, the signal comprising information of a plurality of sets of slot formats for one or more serving cells, wherein each set of slot formats of the plurality of sets of slot formats corresponds to a plurality of frequency segments of each serving cell of the one or more serving cells, wherein the each serving cell of the one or more serving cells is affiliated with the another communication apparatus. The circuitry 1214 (or the at least controller 1206 of the circuitry 1214) may be configured to perform a scheduling procedure based on the information.

According to an alternative embodiment of the present disclosure, the communication apparatus 1200, when in operation, provides functions required for intra-gNB coordination for inter-gNB CLI handling. For example, the communication apparatus 1200 may be a third base station where a first serving cell and a second serving cell is affiliated with the third base station, the circuitry 1214 (or the at least one transmission signal generator 1208 of the circuitry 1214) may be configured to generate a signal comprising information of a plurality of sets of slot formats for the first serving cell, wherein the set of slot formats corresponds to a plurality of frequency segments of the first serving cell and the at least one radio transmitter 1202 may transmit the signal to the second serving cell.

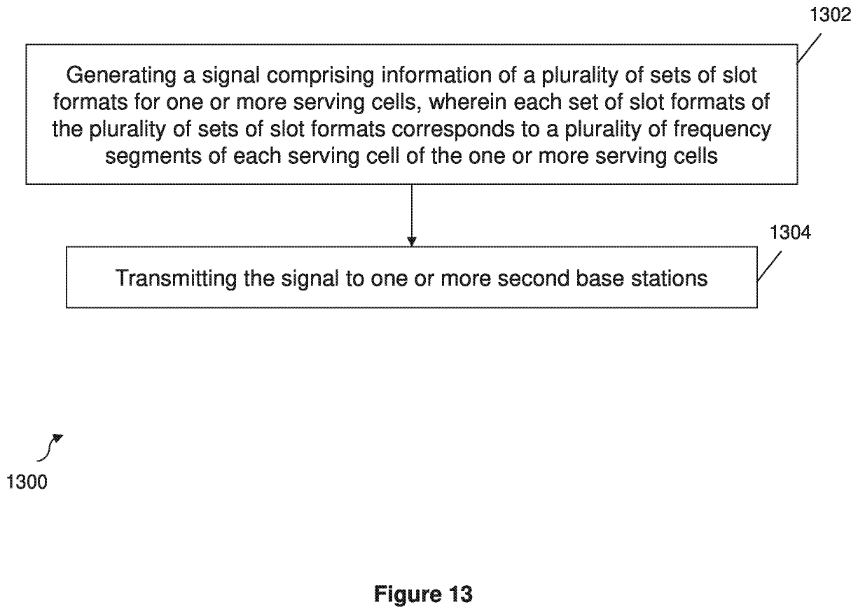

FIG. 13 shows a flowchart 1300 illustrating a communication method for inter-gNB coordination for inter-gNB handling according to various embodiments of the present disclosure. In step 1302, a step of generating a signal comprising information of a plurality of sets of slot formats for one or more serving cells is carried out, wherein each set of slot formats of the plurality of sets of slot formats corresponds to a plurality of frequency segments of each serving of the one or more serving cells. In step 1304, a step of transmitting the signal to one or more second base stations is carried out.

In the following paragraphs, a first embodiment of the present disclosure is explained with reference to an exchange of slot format indicator information with substantially overlapped/shared sub-band allocations for inter-gNB coordination.

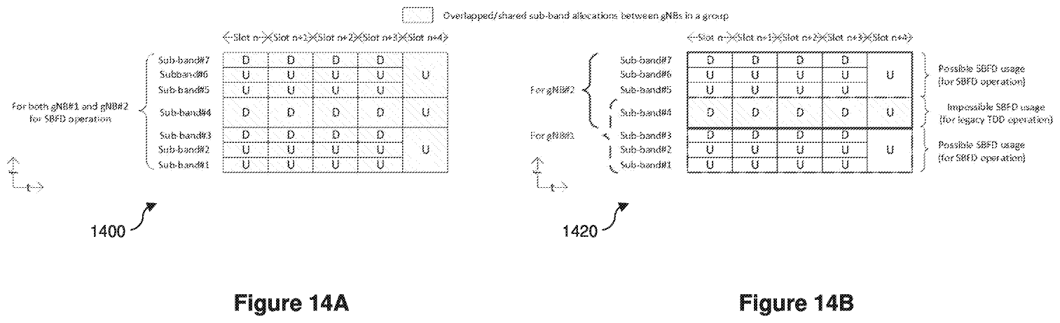

FIG. 14A shows a block diagram 1400 illustrating an exemplary TDD band with fully overlapped/shared sub-band allocations for inter-gNB coordination for inter-gNB CLI handling according to the first embodiment of the present disclosure. In frequency-domain, the sub-bands (e.g., sub-bands #1-7) are defined and fully shared (overlapped) for all cells in a group of neighbouring gNBs (e.g., gNB #1 and gNB #2). There could be multiple sets of sub-bands for multiple groups of gNB and it is not necessary to exchange the SFI info for the sub-bands; whereas in time-domain, based on the sub-bands, multiple slot formats per cell (SFI info) are exchanged between gNBs. Each of the multiple slot formats corresponds to each of the sub-bands.

In one implementation, the multiple slot formats of a cell can be updated based on validity period. In other words, the slot formats are valid during the validity period and when the validity period expires, new slot formats are generated to replace the slot formats at the sub-band. The multiple slot formats of each sub-band of the cell may also be updated with different cycle/timings based on respective validity period. In another implementation, the SPI information is exchanged upon receiving a request of the corresponding gNB.

Each of the multiple slot formats indicates how each of symbols within a single slot is used. Particularly, it defines which symbols are used for uplink, which symbols are used for downlink, and which symbols are used as flexible symbols within a specific slot. In a case when the flexible symbols are semi-static symbols, they can be further configured as downlink or uplink symbols by using a dedicated RRC configuration or a dynamic indication in the serving cell. In other case, the flexible symbols can be used as a guard period for a purpose of beam switching or uplink-downlink switching, etc., when a UE operates in a half-duplex division operation. Moreover, there could be different types of slot formats such that provide a high flexibility of gNB scheduling, especially for TDD operation or SBFD operation. For instance, there could be a type of slot format used for downlink-heavy transmission with uplink symbol(s), or another type of slot format used for uplink-heavy transmission with downlink control symbol(s), or another one used for downlink-heavy transmission without uplink symbol, etc. Therefore, by applying a slot format or combining different slot formats in sequence in time-domain, gNB can configure various different types of scheduling.

Upon receiving the SFI information by the corresponding gNB, at the cell of the corresponding gNB, the multiple slot formats can be signalled to a UE, or one or more UEs of multiple UEs affiliated with the corresponding gNB by using either one or a combination of the following two options: (1) dedicated radio resource control (RRC) configuration, where the multiple slot formats are semi-statically configured to the UE by using a new dedicated RRC parameter; and (2) indication in DCI, where the multiple slot formats are indicated to the UE by enhancing SFI indication with multiple SFI fields in DCI format 2_0, and the position bit of each of the multiple slot formats for each of the sub-bands can be configurable or bitmap.

In option 2, for example, referring to FIG. 14B, it is assumed that a gNB serves a cell, and, SFI_{i,j} is the slot format used for sub-band #j of, gNB. The multiple slot formats are dynamically indicated by using multiple SFI fields in DCI format 2_0. It is also possible to indicate the dynamic slot formats #46-55 as defined in the section 11.1.1 of TS38.213, which are not possibly indicated by using current Rel. 16 (Release 16) inter-gNB coordination.

It is noted that a gNB can be a gNB as defined in TS 38.300 in a non-split gNB scenario or a gNB distributed unit (gNB-DU) as defined in TS 38.401 in a split gNB scenario, and the gNB can serve one or more cells. In the non-split gNB scenario, the information exchange can be performed by between gNBs based on Xn interface, i.e., gNB responsibility, as shown in Fig. XX #0. In the split gNB scenario, the information exchange can be performed by between gNB-Dus via gNB-centric unit (gNB-CU) based on F1 interface, i.e., gNB-DU responsibility, as shown in Figs. XX #1 and XX #2. For example, a gNB exchanges a set of the multiple slot formats of its own cells to neighboring gNB via Xn in the non-split gNB scenario, e.g., gNB #1-to-gNB #2. In the split gNB scenario, a gNB-DU exchanges a set of the multiple slot formats of its own cells to gNB-CU node and then to neighbour gNB-DU via F1 interface, or gNB via F1 and Xn interfaces, e.g., gNB-DU #1-to-gNB-CU-to-gNB-DU #2 via F1 interface, or gNB-DU #1-to-gNB-CU-to-gNB via F1 and Xn interfaces. It is further noted that, according to current specification, a same slot format indicated by SFI is commonly applied for all RB sets for a group of UEs in a serving cell in TDD operation, whereas multiple slot formats SFIs can be applied for different sub-band (each of the sub-bands includes a number of RBs) in SBFD operation. A bitwidth for multiple SFI fields can be provided by higher layer parameter and determined as log_2 (size of the sub-bands). Alternatively, the size of multiple SFI fields can be defined based on the number of gNBs in the group and the sub-bands.

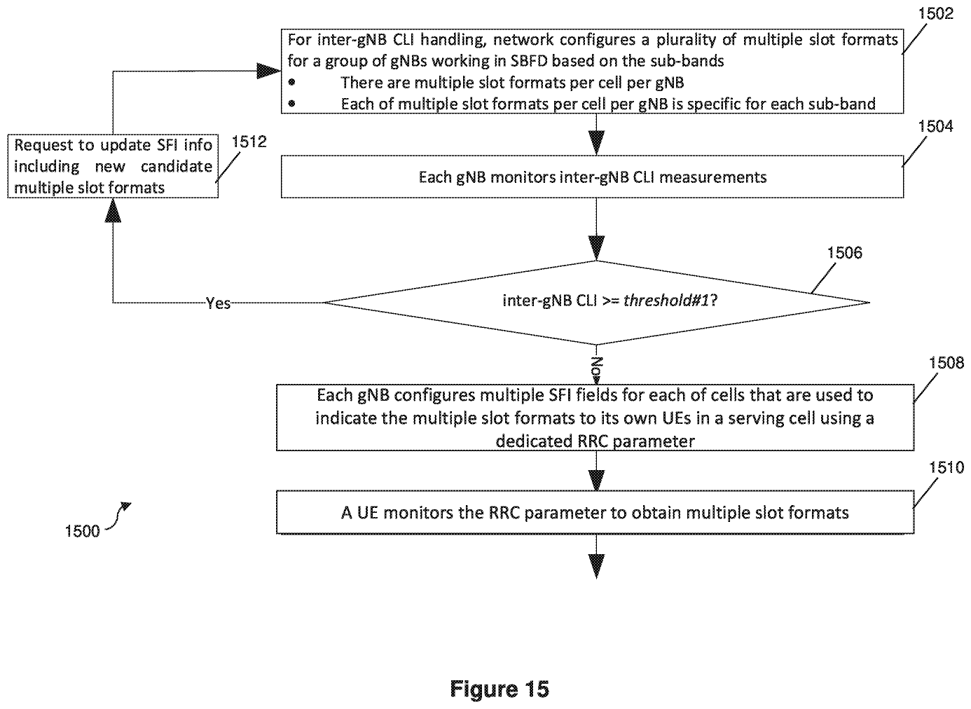

FIG. 15 shows a flowchart 1500 illustrating a first exemplary inter-gNB coordination process (Option 1) for gNB CLI handling according to the first embodiment of the present disclosure. In step 1502, a network configures a plurality of multiple slot formats for a group of gNBs (multiple slot formats per cell per gNB) working in SBFD based on the sub-bands for inter-gNB CLI handling. Each of the multiple slot formats per cell per gNB is specific for each sub-band. In step 1504, each gNB of the group of gNBs monitors inter-gNB CLI measurements. In step 1506, it is determined by each gNB whether the inter-gNB CLI is equal or larger than an inter-gNB CLI threshold level (threshold #1). If the inter-gNB CLI is equal or larger than threshold #1, step 1512 is carried where the gNB requests to update SFI info to include new candidate multiple slot formats. If it is determined that the inter-gNB CLI is lower than threshold #1, the gNB then signals the multiple slot formats to a UE, or one or more UEs of multiple UEs affiliated with the gNB. Steps 1508 and 1510 illustrate the signalling under option 1. Under option 1, each gNB semi-statically configures the multiple slot formats by using a dedicated RRC parameter to its own UE(s) in a serving cell. In step 1508, each gNB configures multiple SFI fields for each of cells that are used to indicate the multiple slot formats to its own UE(s) in a serving cell using a new dedicated RRC parameter. In step 1510, the UE receives the RRC parameter to obtain the multiple slot formats.

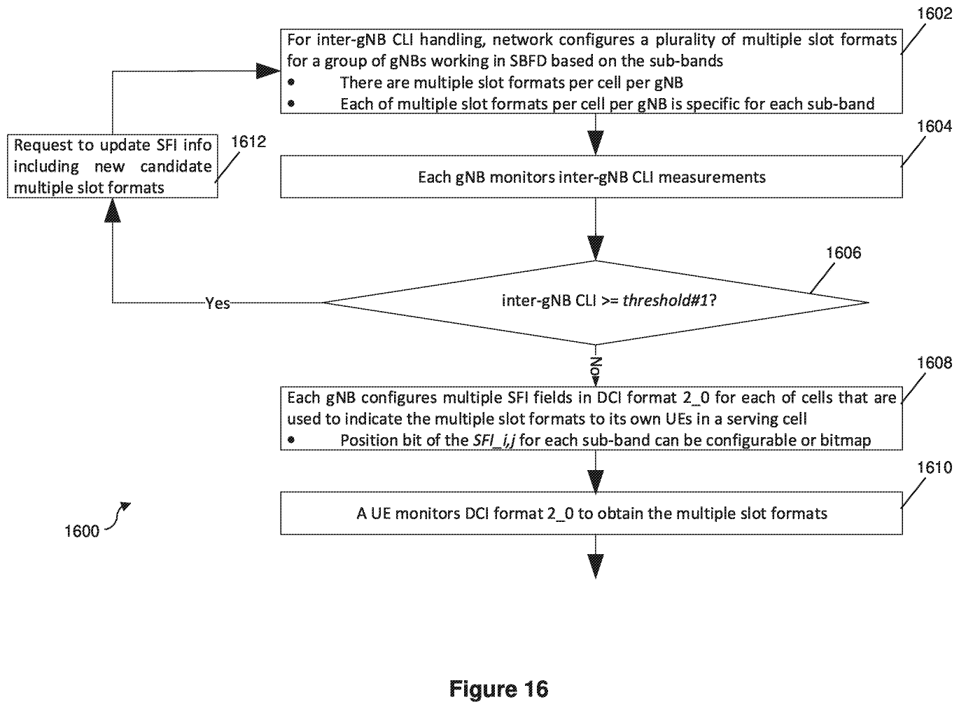

FIG. 16 shows a flowchart 1600 illustrating a second exemplary inter-gNB coordination process (Option 2) for gNB CLI handling according to the first embodiment of the present disclosure. In step 1602, a network configures a plurality of multiple slot formats for a group of gNBs (multiple slot formats per cell per gNB) working in SBFD based on the sub-bands for inter-gNB CLI handling. Each of the multiple slot formats per cell per gNB is specific for each sub-band. In step 1604, each gNB of the group of gNBs monitors inter-gNB CLI measurements. In step 1606, it is determined by each gNB whether the inter-gNB CLI is equal or larger than an inter-gNB CLI threshold level (threshold #1). If the inter-gNB CLI is equal or larger than threshold #1, step 1612 is carried where the gNB requests to update SFI info to include new candidate multiple slot formats. If it is determined that the inter-gNB CLI is lower than threshold #1, the gNB then signals the multiple slot formats to a UE, or one or more UEs of multiple UEs affiliated with the gNB. Steps 1608 and 1610 illustrate the signalling under option 2. In step 1608, each gNB configures multiple SFI fields in DCI format 2_0 for each of cells that are used to indicate the multiple slot formats to its own UE(s) in a serving cell. The position bit of the slot format SFI_{i,j} for each sub-band can be configurable or bitmap. In step 1610, the UE monitors DCI format 2_0 to obtain the multiple slot formats.

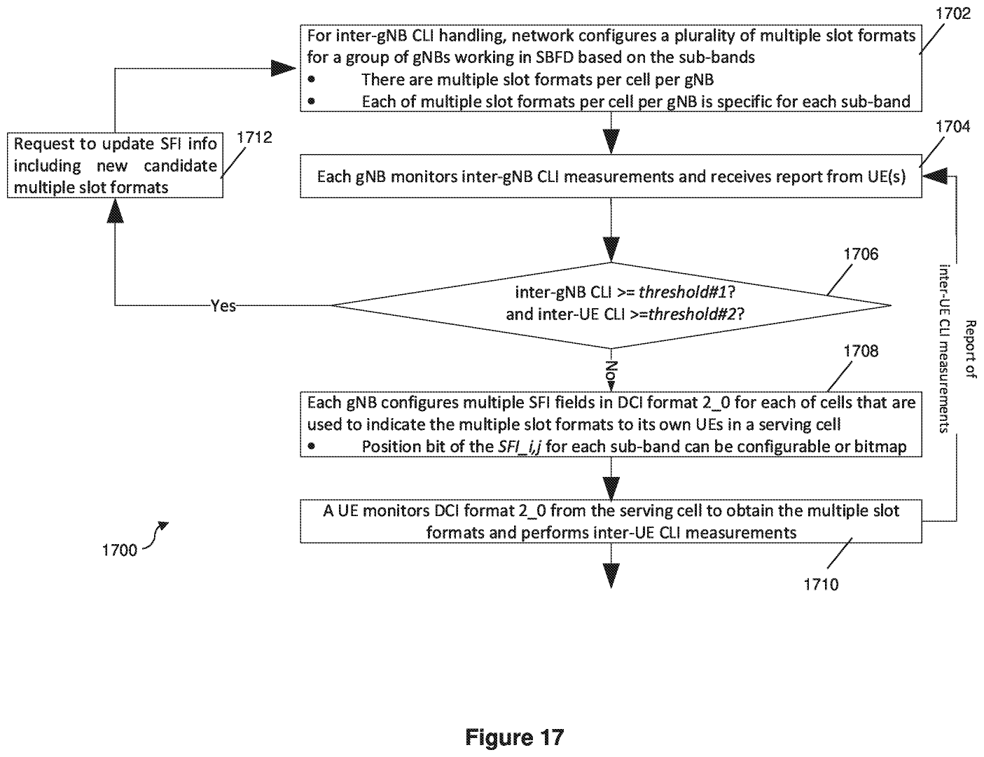

FIG. 17 shows a flowchart 1700 illustrating a third exemplary inter-gNB coordination process (Option 2) for gNB CLI handling according to the first embodiment of the present disclosure. In this example, inter-UE CLI measurement is considered. In particular, in step 1702, a network configures a plurality of multiple slot formats for a group of gNBs (multiple slot formats per cell per gNB) working in SBFD based on the sub-bands for inter-gNB CLI handling. Each of the multiple slot formats per cell per gNB is specific for each sub-band. In step 1704, each gNB of the group of gNBs monitors inter-gNB CLI measurements and receive report from UE(s). In step 1706, it is determined by each gNB whether the inter-gNB CLI is equal or larger than an inter-gNB CLI threshold level (threshold #1) and whether the inter-UE CLI is equal or larger than an inter-UE CLI threshold level (threshold #2). If the inter-gNB CLI is equal or larger than threshold #1 and the inter-UE CLI is equal or larger than threshold #2, step 1712 is carried where the gNB requests to update SFI info to include new candidate multiple slot formats. If it is determined that the inter-gNB CLI is lower than threshold #1 and the inter-UE CLI is lower than threshold #2, the gNB then signals the multiple slot formats to a UE, or one or more UEs of multiple UEs affiliated with the gNB. In step 1708, each gNB configures multiple SFI fields in DCI format 2_0 for each of cells that are used to indicate the multiple slot formats to its own UE(s) in a serving cell (option 2). The position bit of the slot format SFI_{i,j} for each sub-band can be configurable or bitmap. In step 1710, the UE monitors DCI format 2_0 to obtain the multiple slot formats.

In the following paragraphs, a second embodiment of the present disclosure is explained with reference to an exchange of slot form indicator information with partial overlapped/shared sub-band allocations for inter-gNB coordination.

FIG. 14B shows a block diagram 1420 illustrating an exemplary TDD band with partial overlapped/shared sub-band allocations for inter-gNB coordination for inter-gNB CLI handling according to the second embodiment of the present disclosure. In frequency-domain, the sub-bands (e.g., sub-bands #1-7) are defined with partial overlapped sub-bands (e.g., sub-band #4) that are shared between cells in the group of gNBs, whereas there are non-overlapped sub-bands between cells in the group of gNBs (e.g., sub-bands #1-3 allocated to gNB #1; and sub-bands #5-7 allocated to gNB #2).

In one implementation, the partial overlapped sub-bands (e.g., sub-band #4) are defined as “impossible SBFD usage” while the remaining non-overlapped sub-bands (e.g., sub-bands #1-3 and #5-7) are defined as “possible SBFD usage”, as illustrated in FIG. 14B. In an alternative implementation, the partial overlapped sub-bands (e.g., sub-band #4) are defined as “possible SBFD usage” while the remaining non-overlapped sub-bands (e.g., sub-bands #1-3 and #5-7) are defined as “impossible SBFD usage”. Yet in another implementation, a combination of all sub-bands in the group is defined as “possible SBFD usage”. Essentially, the multiple slot formats in the sub-bands defined as “possible SBFD usage” are exchanged. It restricts the amount of the SFI information exchange for only possible SBFD usage, thereby reducing the numbered of sub-bands used in SBFD operation, the required signalling between gNBs as well as reducing CLI.

In time-domain, based on the sub-bands within the “possible SBFD usage”, multiple slot formats per cell (SFI info) are exchanged between gNBs. The remaining operations are similar to those shown in the first embodiment based on the multiple slot formats on the sub-bands within the “possible SBFD usage”.

For example, in one implementation, the multiple slot formats of each sub-band within only the “possible SBFD usage” of a cell can be updated based on their validity periods. Alternatively, the multiple slot formats of each sub-band within only the “impossible SBFD usage” of a cell are updated based on their validity periods. As such, the multiple slot formats of each sub-band of the cell may also be updated with different cycles/timings based on respective validity periods. In another implementation, the SFI information is exchanged upon receiving a request of the corresponding gNB.

In addition, upon receiving the SFI information by the corresponding gNB, at the cell of the corresponding gNB, the multiple slot formats can be signalled to a UE, or one or more UEs of multiple UEs affiliated with the corresponding gNB by using either one or a combination of the following two options: (1) dedicated radio resource control (RRC) configuration, where the multiple slot formats are semi-statically configured to the UE by using a new dedicated RRC parameter; and (2) indication in DCI, where the multiple slot formats are indicated to the UE by enhancing SFI indication with multiple SFI fields in DCI format 2_0, and the position bit of each of the multiple slot formats for each of the sub-bands can be configurable or bitmap.

It is noted that the number of the multiple slot formats in the first embodiment with fully overlapped sub-band allocations can be different from that of the second embodiment with partial overlapped sub-band allocations depending on the set of sub-bands within “possible SBFD usage”.

In one implementation of various embodiments in the present disclosure, in time-domain, a same slot format per cell used for all the sub-bands (or all the sub-bands within “possible SBFD usage”) is exchanged between a group of gNBs.

TABLE 3
Example of exchanging multiple slot formats per cell
per gNB (e.g., gNB₁, gNB₂, gNB₃; or gNB under the
index number 1, 2, 3) between gNBs for inter-gNB
coordination for inter-gNB CLI handling according
to an embodiment of the present disclosure, where
a same slot format per cell is used across all
sub-bands. SFIᵢ indicates the slot format at row
i (time-domain resource allocation for a gNBᵢ
across all sub-bands in the legacy TDD band).
In other words, SFI_{i,}is the slot format used
across all sub-band #1-j of gNBᵢ.

| gNB index gNBᵢ | Multiple slot format SFIᵢ | Multiple slots |
|---|---|---|
| 1 | SFI₁ = 0 | 5 |
| 2 | SFI₂ = 0 | 5 |
| 3 | SFI₃ = 0 | 5 |

In another implementation of various embodiments of the present disclosure, in frequency-domain, instead of using the defined sub-bands, the sub-bands can be configured/updated (e.g., with different bandwidths and/or number of sub-bands) and exchanged. In time-domain, the same contents previously described in the first or second embodiment can be used. The information exchange includes SFI information as well as the sub-bands of each of cells. Advantageously, it provides more flexibility of RRC configurations for SBFD operation. Optionally, at each cell in the group, the configured sub-bands in frequency-domain can be dynamically activated or deactivated in time-domain (i.e., for frequency resource).

TABLE 4
Example of exchanging multiple slot formats per cell per
gNB (e.g., gNB₁, gNB₂, gNB₃; or gNB under the index number
1, 2, 3) between gNBs for inter-gNB coordination for inter-
gNB CLI handling according to an embodiment of the present
disclosure, where the sub-band are configured.

| gNB index | | Multiple |
|---|---|---|
| gNBᵢ | Slot format SFIᵢ for sub-bands | slots |
| 1 | SFI_{1, 1} for sub-band #1; SFI_{1, 2} for sub-band #2; | 5 |
| | SFI_{1, 3} for sub-band #3 | |
| 2 | SFI_{2, 1} for sub-band #1; SFI_{2, 2} for sub-band #2; | 5 |
| | SFI_{2, 3} for sub-band #3 | |
| 3 | SFI_{3, 1} for sub-band #1; SFI_{3, 2} for sub-band #2; | 5 |
| | SFI_{3, 3} for sub-band #3 | |

According to yet another implementation of various embodiments of the present disclosure, in time-domain, the multiple slot formats per cell can be new semi-static (SBFD) slot formats per cell that can exchanged between gNBs. Such new semi-static (SBFD) slot formats per cell are configurable by using a new RRC parameter (e.g., intendedXDD-UL-DL-Configuration-r18) in current IntendedTDD-DL-ULConfiguration-NR, in addition to the legacy semi-static (TDD) slot format. A different direction other than configured by the legacy (TDD) semi-static slot format is indicated for a slot/symbol by using the new RRC parameter such as tdd-UL-DL-ConfigurationXDD-r18.

Such new semi-static (SBFD) slot format allows overwriting the legacy semi-static “D” and/or “U” symbol/slots, in addition to F symbol/slot. Each gNB in the group uses the corresponding overwritten slot formats to schedule its own UEs. The overwriting rule is illustrated in Table 5.

TABLE 5
Example overwriting rule for new semi-static (SBFD) slot formats
according to an embodiment of the present disclosure.

| | | | | | | | |
|---|---|---|---|---|---|---|---|
| Legacy semi-static slot format | D | D | D | U | F | F | F |
| New semi-static slot format | D | U | F | U | D | U | F |
| Proposed overwriting result | D | U | F | U | D | U | F |

As shown in Table 5, the legacy semi-static slot format “DDDUFFF” can be overwritten to be “DUFUFUF”, where the 2^{nd} slot format “D” and 3^{rd} slot format “D”, in addition to overwriting rule to overwrite from “F” to “D” and “U” in the 5^{th} and 6^{th} slot formats “F” according to Release 15/16/17, can be overwritten to “U” and “F” respectively. Such overwriting rule is different from that of the Release 15/16/17 where only slot format “F” can be overwritten.

Optionally, possible SBFD symbol/slot usage and impossible SBFD symbol/slot usage as defined in the second embodiments can be introduced. In such cases, possible SBFD symbol/slot (which can be legacy semi-static D and/or U symbol/slot) is the symbol/slot that is allowed to be overwritten other than legacy semi-static F symbol/slot.

It is noted that, in Rel. 15/16/17, when configuring slot formats, the overwriting rules are shown as follows: (i) semi-static D and U symbols cannot be overwritten by either UE-dedicated RRC or dynamic configuration (using DCI format 2_0); (ii) only semi-static F symbol can be overwritten to D or U by UE-dedicated RRC or DCI format 2_0; and (iii) if a semi-static F symbol is not overwritten to D or U symbol by either UE-dedicated RRC or DCI format 2_0, the UE follows scheduling DCI (e.g., DCI format 0_0/0_1/0_2/1_0/1_1/1_2) to decide on whether to transmit or receive.

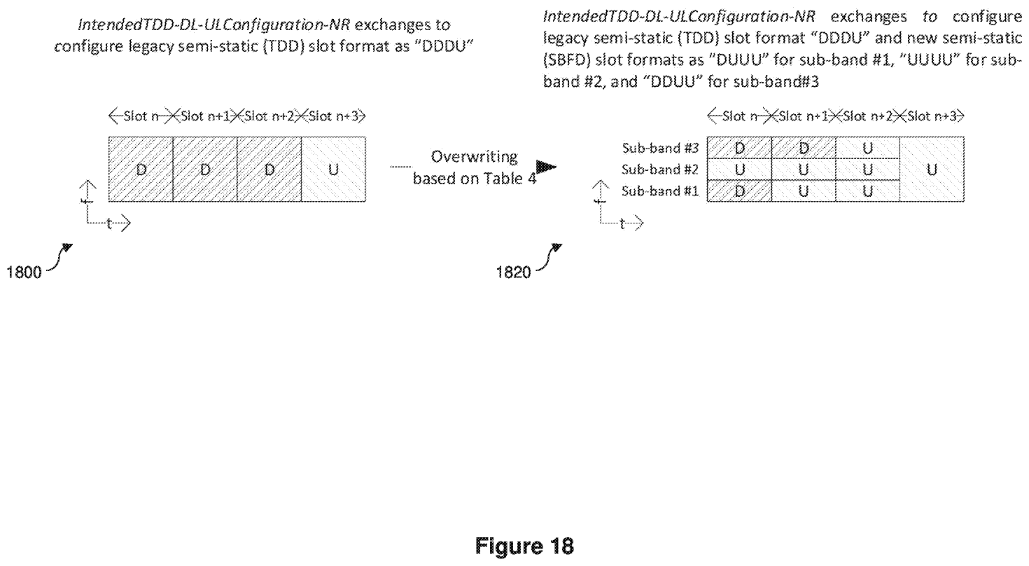

FIG. 18 shows a block diagram illustrating an exemplary TDD band with new semi-static slot format for inter-gNB coordination for inter-gNB CLU handling according to an embodiment of the present disclosure. The slot format “DDDU” of legacy TDD band 1800 is configured and overwritten into “DUUU” for sub-band #1, “UUUU” for sub-band #2 and “DDUU” for sub-band #3 in the new semi-static SBFD 1820 by exchanging IntendedTDD-DL-ULConfiguration-NR.

According to various embodiments of the present disclosure, the information exchange can include additionally one or more of the following:
Physical gNB identity (ID)
Sounding reference signal (SRS) configurations
Beam coordination (pairs of beam indexes between gNBs)
Inter-gNB CLI and/or inter-UE CLI measurements (e.g., sounding reference signal-reference signal received power (SRS-RSRP) and CLI received signal strength indicator (CLI-RSSI))
Sub-band indices

SRS-RSRP refers to a linear average of the power contributions of the SRS to be measured over the configured resource elements within the considered measurement frequency bandwidth in the time resources in the configured measurement occasions; whereas CLI-RSSI refers to a linear average of the total received power observed only in certain OFDM symbols of measurement time resource(s), in the measurement bandwidth, over the configured resource elements for measurement by the UE.

According to various embodiments of the present disclosure, the information exchange can also be performed by wireless-based or backhaul-based framework. Although the embodiments are described with respect to a group of neighbouring gNBs, it is understood that the embodiments can be applied to all gNBs in the network.

Although it is not described, a skilled person would understand that such inter-gNB coordination for gNB CLI handling is applicable for intra-gNB coordination for cell CLI-handling, assuming one gNB serves multiple cells.

As mentioned above, a table of multiple slot formats for a group of neighbour gNBs can be configurable by IntendedXDD-UL-DL-Configuration-r18 in IntendedTDD-DL-ULConfiguration-NR, where gNB_i is the index of gNB in the group GroupOfgNB, slotConfiguration-List_XDD includes candidate dynamic slot formats for XDD operation (e.g., the slot formats #46-#55 in TS38.213), and SFI_ij indicates multiple dynamic slot formats for the predefined 3 sub-bands, wherein the sub-band indices from 1 to 3, of gNB_i. Examples of formats of IntendedTDD-DL-ULConfiguration-NR, IntendedXDD-UL-DL-Configuration-r18 and SlotConfiguration_XDD are as follows:

IntendedTDD-DL-ULConfiguration-NR ::= SEQUENCE {

| | |
|---|---|
| nrscs | NRSCS, |
| nrCyclicPrefix | NRCyclicPrefix, |
| nrDL-ULTransmissionPeriodicity | NRDL-ULTransmissionPeriodicity, |
| slotConfiguration-List | SlotConfiguration-List, |
| iE-Extensions | ProtocolExtensionContainer { {IntendedTDD-DL- |

ULConfiguration-NR-ExtIEs} } OPTIONAL,

| | |
|---|---|
| IntendedXDD-UL-DL-Configuration-r18 | intendedXDD-UL-DL-Configuration-r18, |

...}
IntendedXDD-UL-DL-Configuration-r18::= SEQUENCE {

| | |
|---|---|
| gNB_i | SIZE(1.. maxNofgNB-1), |
| SlotConfigurationt_XDD | SlotConfiguration_XDD, |
| SFI_ij | SEQUENCE (SIZE(1.. 3) OF SetupRelease {SlotConfiguration_XDD}, |
| ValidityPeriod | ENUMERATED {a_ms, b_ms, c_ms) OPTIONAL, |

...}
SlotConfiguration_XDD ::= SEQUENCE {

| | |
|---|---|
| numberofDLSymbols | INTEGER (0..13), |
| numberofULSymbols | INTEGER (0..13), |
| iE-Extension | ProtocolExtensionContainer { {slotConfiguration_XDD-ExtIEs} } |

```
  OPTIONAL,
  ...}
```

In one alternative implementation, for inter-gNB CLI handling in SBFD operation, information exchange between gNBs is dynamically performed and updated frequently. The information exchange includes at least set of sub-bands and the corresponding multiple slot formats. For a wireless-based framework, a gNB sends the information exchange in a DCI to another gNB over the air interface; whereas for a backhaul-based framework, a gNB sends the information in the IntendedTDD-DL-ULConfiguration-NR IE with the transmission periodicity to another gNB as per slot-basis over the wired backhaul network. However, as this may create a huge amount of information exchange and is more suitable to be applied for intra-gNB coordination for inter-cell CLI handling, where a gNB serves multiple cells in centralized RAN, or sector operation, etc.

For the above embodiments, “exchange between gNBs” may be replaced with “transmits to another gNBs” or “sends to another gNBs”. Further, “exchange between gNBs” may be replaced with “transmits to a user equipment (UE)” or “sends to a UE”.

According to the present disclosure, various examples below have been described:
1. A first base station comprising:
   circuitry which, in operation, is configured to generate a signal comprising information of a plurality of sets of slot formats for one or more serving cells, wherein each set of slot formats of the plurality of sets of slot formats corresponds to a plurality of frequency segments of each serving cell of the one or more serving cells; and
   a transmitter which, in operation, transmits the signal to one or more second base stations.
2. The first base station of example 1, wherein the plurality of frequency segments of the each serving cell of the one or more serving cells is formulated by dividing a frequency band of the each serving cell of the one or more serving cells.
3. The first base station of example 1 or 2, wherein each slot format of the each set of slot formats of the plurality of sets of slot formats corresponds to one of the plurality of frequency segments of the each serving cell of the one or more serving cells.
4. The first base station of any one of examples 1-3, wherein the plurality of frequency segments do not overlap one another.
5. The first base station of any one of examples 1-4, wherein each slot format of the each set of slot formats of the plurality of sets of slot formats indicates a set of transmission directions in a specific slot, each of the set of transmission directions being an uplink direction, a downlink direction or both.
6. The first base station of any one of examples 1-5, wherein the circuitry is configured to generates the signal in response to an expiration of a validity period.
7. The first base station of any one of examples 1-5, wherein a validity period of one set of slot formats of the plurality of sets of slot formats is different from that of another set of slot formats of the plurality of sets of slot formats.
8. The first base station of any one of examples 1-4, wherein the signal comprises information of a validity period of each set of slot formats of the plurality of sets of slot formats, and the circuitry is configured to generate a new set of slot formats to replace the each set of slot formats of the plurality of sets of slot formats in response to an expiration of the validity period.
9. The first base station of example 8, wherein each slot format of the each set of slot formats of the plurality of sets of slot formats indicates a set of transmission directions in a specific slot, the transmission direction being an uplink direction, a downlink direction or both, and the new set of slot formats replaces only one or more transmission directions among of the set of transmission directions in the specific slot.
10. The first base station of any one of examples 1-9, wherein the transmitter further transmits second information based on the information of the plurality of sets of slot formats to at least one of a plurality of user equipment using one or a combination of a higher layer parameter or downlink control information.
11. The first base station of any one of examples 1-10, further comprising a receiver which, in operation, receive a request from one of the one or more second base stations, wherein the circuitry is further configured to generate a plurality of new sets of slot formats corresponding to the plurality of frequency segments for the one or more serving cells and the signal comprising the information of the plurality of new sets of slot formats in response to receiving the request.
12. The first base station of any one of examples 1-11, wherein the plurality of sets of slot formats comprises a first set of slot formats and a second set of slot formats, and the one or more serving cells comprises one or more first serving cells affiliated with the first base station and one or more second serving cells affiliated with one of the one or more second base station, wherein the first set of slot formats corresponds to one or more first frequency segments, among the plurality of frequency segments, of the one or more first serving cells among, and the second set of slot formats corresponds to one or more second frequency segments, among the plurality of frequency segments, of the one or more second serving cells, and wherein at least one of the one or more first frequency segments does not overlap the one or more second frequency segments and/or at least one of the one or more second frequency segments does not overlap the one or more first frequency segments.
13. The first base station of example 12, wherein the information of the plurality of sets of slot formats comprises information of the first set of slot formats and the second set of slot formats corresponding to only the one or more first frequency segments that do not overlap the one or more second frequency segments and the one or more second frequency segments that do not overlap the one or more first frequency segments, respectively.
14. The first base station of example 12, wherein the information of the plurality of sets of slot formats comprises information of the first set of slot formats and the second set of slot formats corresponding to only the one or more first frequency segments that overlap the one or more second frequency segments.
15. The first base station of example 12, wherein the information of the plurality of sets of slot formats comprises information of the first set of slot formats and the second set of slot formats corresponding to (i) at least one of the one or more first frequency segments that do not overlap the one or more second frequency segments and the one or more second frequency segments that do not overlap the one or more first frequency segments and (ii) at least one of the one or more first frequency segments that overlap the one or more second frequency segments.
16. The first base station of any one of examples 1-15, wherein the each set of slot formats the plurality of sets of slot formats corresponding to the plurality of frequency segment of the each serving cell of the one or serving cells comprises a single slot format.
17. The first base station of any one of examples 1-16, wherein the circuitry is further configured to generate a second signal comprising information of a plurality of updated frequency segments, wherein the each set of slot formats of the plurality of sets of slot formats corresponds to the plurality of updated frequency segments of the each serving cell of the one or more serving cells.
18. The first base station of any one of examples 1-17, wherein the transmitter is configured to transmit the signal to the one or more second base stations through a radio resource control signaling
19. The first base station of any one of examples 1-17, wherein the transmitter is configured to transmit the signal to the one or more second base stations at every regular interval in downlink control information wirelessly or through a radio resource control signaling over a wired network.
20. The first base station of any one of examples 1-19, wherein the signal comprises third information, the third information comprising at least one of a physical cell identity, indices of the plurality of frequency segments, a configuration of a sounding reference signal, beam coordination information, beam indices and cross-link interference measurements in the each serving cell of the one or more serving cells.
21. A second base station, comprising:
   a receiver which, in operation, receives a signal from a first base station, the signal comprising information of a plurality of sets of slot formats for one or more serving cells, wherein each set of slot formats of the plurality of sets of slot formats corresponds to a plurality of frequency segments of each serving cell of the one or more serving cells, wherein the each serving cell of the one or more serving cells is affiliated with the first base station; and
   circuitry which, in operation, is configured to perform a scheduling procedure based on the information.
22. A third base station, wherein a first serving cell and one or more second serving cells are affiliated with the third base station, comprising:
   circuitry which, in operation, is configured to generate a signal comprising information of a set of slot formats for the first serving cell, wherein the set of slot formats corresponds to a plurality of frequency segments of the first serving cell; and
   a transmitter which, in operation, transmits the signal to the one or more second serving cells.
23. A communication method, comprising:
   generating a signal comprising information of a plurality of sets of slot formats for one or more serving cells, wherein each set of slot formats of the plurality of sets of slot formats corresponds to a plurality of frequency segments of each serving cell of the one or more serving cells; and
   transmitting the signal to one or more second base stations.

In the following paragraphs, certain exemplifying embodiments are explained with reference to terms related to 5G core network and the present disclosure regarding communication apparatuses and methods for allocating one or more additional operating windows between two semi-statically configured SL DRX cycles for a reception or a transmission of a SL signal, namely:

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sidelink control information (SCI) or the 2nd stage SCI.

### Base Station

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in sidelink communication, a terminal may be adopted instead of a base station. The base station may be a relay apparatus that relays communication between a higher node and a terminal. The base station may be a roadside unit as well.

### Uplink/Downlink/Sidelink

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, time resource units are not limited to one or a combination of slots and symbols, and may be time resource units, such as frames, super-frames, subframes, slots, time slot sub-slots, mini-slots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g. cellular (cell) phone, smart phone), a tablet, a personal computer (PC) (e.g. laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A first base station comprising:
circuitry which, in operation, is configured to generate a signal comprising information of a plurality of sets of slot formats for one or more serving cells, wherein each set of slot formats of the plurality of sets of slot formats corresponds to a plurality of frequency segments of each serving cell of the one or more serving cells; and
a transmitter which, in operation, transmits the signal to one or more second base stations.

2. The first base station of claim 1, wherein the plurality of frequency segments of the each serving cell of the one or more serving cells is formulated by dividing a frequency band of the each serving cell of the one or more serving cells.

3. The first base station of claim 1, wherein each slot format of the each set of slot formats of the plurality of sets of slot formats corresponds to one of the plurality of frequency segments of the each serving cell of the one or more serving cells.

4. The first base station of claim 1, wherein the plurality of frequency segments do not overlap one another.

5. The first base station of claim 1, wherein each slot format of the each set of slot formats of the plurality of sets of slot formats indicates a set of transmission directions in a specific slot, each of the set of transmission directions being an uplink direction, a downlink direction or both.

6. The first base station of claim 1, wherein a validity period of one set of slot formats of the plurality of sets of slot formats is different from that of another set of slot formats of the plurality of sets of slot formats.

7. The first base station of claim 1, wherein the signal comprises information of a validity period of each set of slot formats of the plurality of sets of slot formats, and the circuitry is configured to generate a new set of slot formats to replace the each set of slot formats of the plurality of sets of slot formats in response to an expiration of the validity period.

8. The first base station of claim 7, wherein each slot format of the each set of slot formats of the plurality of sets of slot formats indicates a set of transmission directions in a specific slot, the transmission direction being an uplink direction, a downlink direction or both, and the new set of slot formats replaces only one or more transmission directions among of the set of transmission directions in the specific slot.

9. The first base station of claim 1, wherein the transmitter further transmits second information based on the information of the plurality of sets of slot formats to at least one of a plurality of user equipment using one or a combination of a higher layer parameter or downlink control information.

10. The first base station of claim 1, wherein the plurality of sets of slot formats comprises a first set of slot formats and a second set of slot formats, and the one or more serving cells comprises one or more first serving cells affiliated with the first base station and one or more second serving cells affiliated with one of the one or more second base station, wherein the first set of slot formats corresponds to one or more first frequency segments, among the plurality of frequency segments, of the one or more first serving cells among, and the second set of slot formats corresponds to one or more second frequency segments, among the plurality of frequency segments, of the one or more second serving cells, and wherein at least one of the one or more first frequency segments does not overlap the one or more second frequency segments and/or at least one of the one or more second frequency segments does not overlap the one or more first frequency segments.

11. The first base station of claim 1, wherein the circuitry is further configured to generate a second signal comprising information of a plurality of updated frequency segments, wherein the each set of slot formats of the plurality of sets of slot formats corresponds to the plurality of updated frequency segments of the each serving cell of the one or more serving cells.

12. The first base station of claim 1, wherein the transmitter is configured to transmit the signal to the one or more second base stations through a radio resource control signaling.

13. The first base station of claim 1, wherein the signal comprises third information, the third information comprising at least one of a physical cell identity, indices of the plurality of frequency segments, a configuration of a sounding reference signal, beam coordination information, beam indices and cross-link interference measurements in the each serving cell of the one or more serving cells.

14. A third base station, wherein a first serving cell and one or more second serving cells are affiliated with the third base station, comprising:
circuitry which, in operation, is configured to generate a signal comprising information of a set of slot formats for the first serving cell, wherein the set of slot formats corresponds to a plurality of frequency segments of the first serving cell; and
a transmitter which, in operation, transmits the signal to the one or more second serving cells.

15. A communication method, comprising:
generating a signal comprising information of a plurality of sets of slot formats for one or more serving cells, wherein each set of slot formats of the plurality of sets of slot formats corresponds to a plurality of frequency segments of each serving cell of the one or more serving cells; and
transmitting the signal to one or more second base stations.
